(19) United States
(12) Patent Application Publication
(10) Pub. No.: US 2006/0283283 A1
(43) Pub. Date: Dec. 21, 2006

(54) Shaft and hub coupling structure for recliners

(76) Inventors: Gi Deuk Jeong, Gyeongju-si (KR); Jae Won Cha, Gyeongju-si (KR)

Correspondence Address: DICKSTEIN SHAPIRO LLP, 1825 EYE STREET NW, Washington, DC, 20006-5403, US

(21) Appl. No.: 11/314,345

(22) Filed: Dec. 22, 2005

(30) Foreign Application Priority Data
Jun. 21, 2005 (KR) 10-2005-0053452

(51) Int. Cl. G05G 5/06

(52) U.S. Cl. 74/535

(57) ABSTRACT

Disclosed herein is a shaft and hub coupling structure for recliners. The shaft and hub coupling structure of the present invention ensures stable and silent motion of the shaft and the hub, maintains sufficient strength of the shaft, and makes it possible for a process of coupling the shaft to the hub to be easily and correctly conducted.

### BACKGROUND OF THE INVENTION

1. Field of the Invention

The present invention relates generally to recliners for adjusting tilting angles of seat backs and, more particularly, to a shaft and hub coupling structure which makes it possible for the shaft and the hub, used in a recliner, to be easily and correctly coupled to each other.

2. Description of the Related Art

FIG. 1 is an exploded perspective view showing an example of a typical recliner to which the present invention may be applied.

The recliner includes a stationary plate 500 and a movable plate 502 which are respectively fastened to a seat cushion and a seat back, and engage with each other by internal gears having numbers of teeth that are different by one or more. The recliner further includes a circular boss 501 which is provided in the stationary plate 500 and has the same rotation center as that of a ring gear 504 which is the internal gear of the stationary plate 500. The recliner further includes a hub 506 which is splined to a shaft 516 that is inserted through the circular boss 501 and provides a rotating force. The recliner further includes a circular hole 510 which is formed inside a pinion 508, which is the internal gear of the movable plate 502, and has the same rotation center as that of the pinion 508. The recliner further includes a pair of wedge blocks 512, a cam 514 and a bearing 515 which are interposed between the circular boss 501 and the circular hole 510 and act such that the pinion 508 engages with the ring gear 504.

The bearing 515 is inserted into the circular hole 510. The cam 514 is inserted into the bearing 515. Two releasing stoppers are provided in the cam 514. The wedge blocks 512 are inserted in a space defined between the two releasing stoppers and between the cam 514 and the circular boss 501 and are supported by a spring 517 while being biased in directions away from each other by the spring 517.

When the hub 506 rotates, the cam 514 rotates the wedge block 512. Then, the pinion 508 of the movable plate 502 is rotated along the ring gear 504 by the rotation of the wedge block 512. As a result, the movable plate 502 rotates with respect to the stationary plate 500, thus adjusting a tilting angle of the seat back with respect to the seat cushion.

A recliner having the above-mentioned construction is mounted to each of opposite sides of the seat. The shaft 516 is inserted into the hubs 506 of the two recliners that are located at opposite positions. Furthermore, the shaft 516 is coupled to a separate motor so that the tilting angle of the seat back can be adjusted by the operation of the motor.

Therefore, when assembling the seat, a process of coupling the shaft 516 to the hubs 506 of the two opposite recliners is required. At this time, the hubs 506 must be coupled to the shaft 516 while inclination angles of the two recliners correspond to each other. However, because the teeth of the shaft 516 and the hub 506, which are splined to each other, have relatively small circumferential pitches and, as well, the shape and arrangement of the teeth are constant, it is not easy to couple the opposite ends of the shaft 516 to the hubs 506 while confirming the correspondence of the inclination angles of the recliners with the naked eyes.

### SUMMARY OF THE INVENTION

Accordingly, the present invention has been made keeping in mind the above problems occurring in the prior art, and an object of the present invention is to provide a shaft and hub coupling structure for recliners which makes it possible for the shaft and the hub to be easily and correctly coupled to each other.

In order to accomplish the above object, the present invention provides a shaft and hub coupling structure for recliners, including: a plurality of external teeth protruding from a circumferential outer surface of the shaft, the external teeth spaced apart from each other at regular angular intervals; and a plurality of internal teeth protruding from an inner edge of the hub, into which the shaft is inserted, the internal teeth being spaced apart from each other at regular angular intervals to correspond to spaces between the external teeth of the shaft, so that the hub is splined to the shaft. Two external teeth among the external teeth of the shaft each include a depression part which is defined by being more depressed than outlines of other external teeth of the shaft. The hub includes supplementary root parts protruding towards the depression parts of the shaft such that, when the hub is oriented in a direction in which the supplementary root parts correspond to the depression parts of the shaft, the hub is fitted over the shaft. The two external teeth of the shaft, each having the depression part, are asymmetrically positioned to one side based on a center of the shaft in a cross-section of the shaft. The supplementary root parts of the hub contact to the two external teeth of the shaft.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing the construction of a typical recliner;

FIGS. 2 and 3 are sectional views showing shafts and hubs, according to a first embodiment of the present invention;

FIGS. 4 through 6 are sectional views showing shafts and hubs, according to a second embodiment of the present invention; and

FIGS. 7 and 8 are sectional views showing shafts and hubs, according to a third embodiment of the present invention.

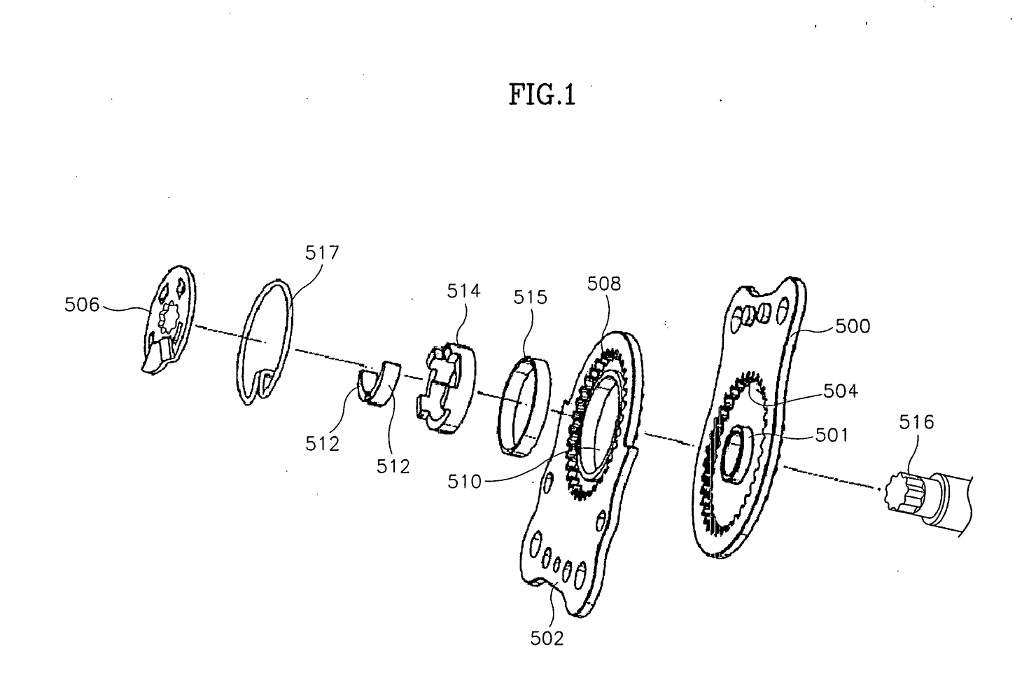

### DESCRIPTION OF THE PREFERRED EMBODIMENTS

Hereinafter, preferred embodiments of the present invention will be described with reference to the attached drawings.

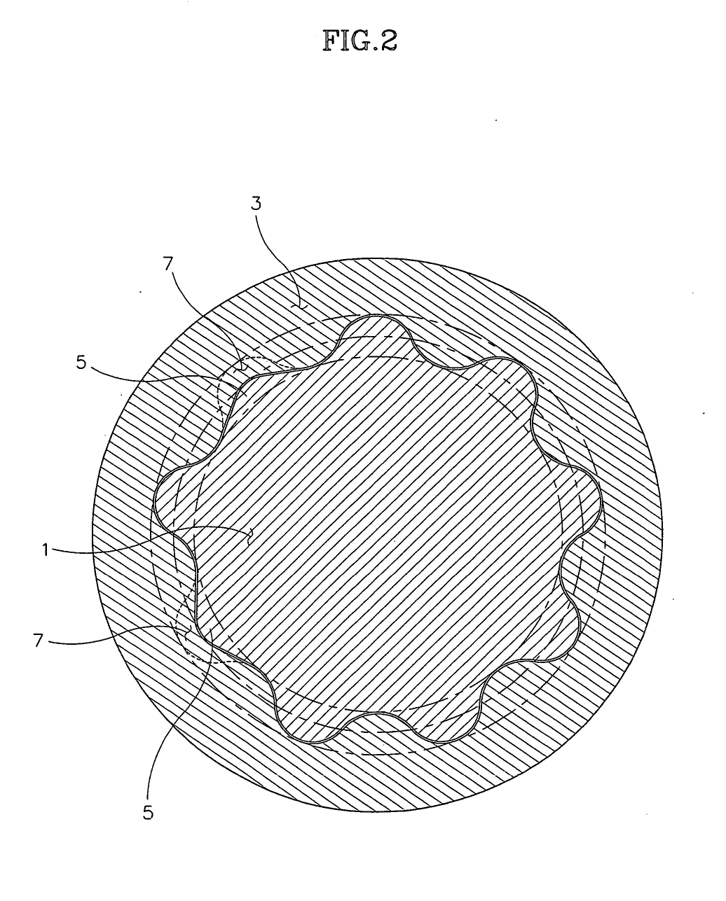

FIG. 2 is a transverse sectional view showing a shaft 1 over which a hub 3 is fitted.

As shown in FIG. 2, a plurality of external teeth, having the same shape, is provided around a circumferential outer surface of the shaft 1. The external teeth are spaced apart from each other at regular angular intervals. A plurality of internal teeth is provided around an inner edge of the hub 3, into which the shaft 1 is inserted. The internal teeth have the same shape and are spaced apart from each other at regular angular intervals to correspond to spaces between the external teeth of the shaft 1, so that the hub 3 is splined to the shaft 1.

Among the external teeth of the shaft 1, two external teeth 5, which are asymmetrically positioned to one side based on the center of the shaft 1 in the cross-section of the shaft 1, have heights lower than the heights of other external teeth, thus defining depression parts (because these portions correspond to supplementary root parts, which will be explained herein later, reference numerals thereof are omitted in the drawings).

The hub 3 includes the supplementary root parts 7 which protrude from the inner edge of the hub 3 to positions higher than other roots of the hub 3, thus corresponding to the two external teeth of the shaft 1 having the depression parts, and contacting the circumferential outer surface of the shaft 1.

“The two lower external teeth 5 (that is, the teeth having the depression parts) are asymmetrically positioned to one side based on the center of the shaft 1 in the cross-section of the shaft 1” means that the two lower external teeth 5 may be positioned at any positions other than opposite positions based on the center of the shaft 1 on the cross-section of the shaft 1.

If the two lower external teeth 5 having the depression parts are positioned at opposite positions based on the center of the shaft 1, the hub 3 may be coupled to the shaft 1 at increments of 180°. To avoid this case, in the present invention, two lower external teeth 5 must be asymmetrically positioned to one side.

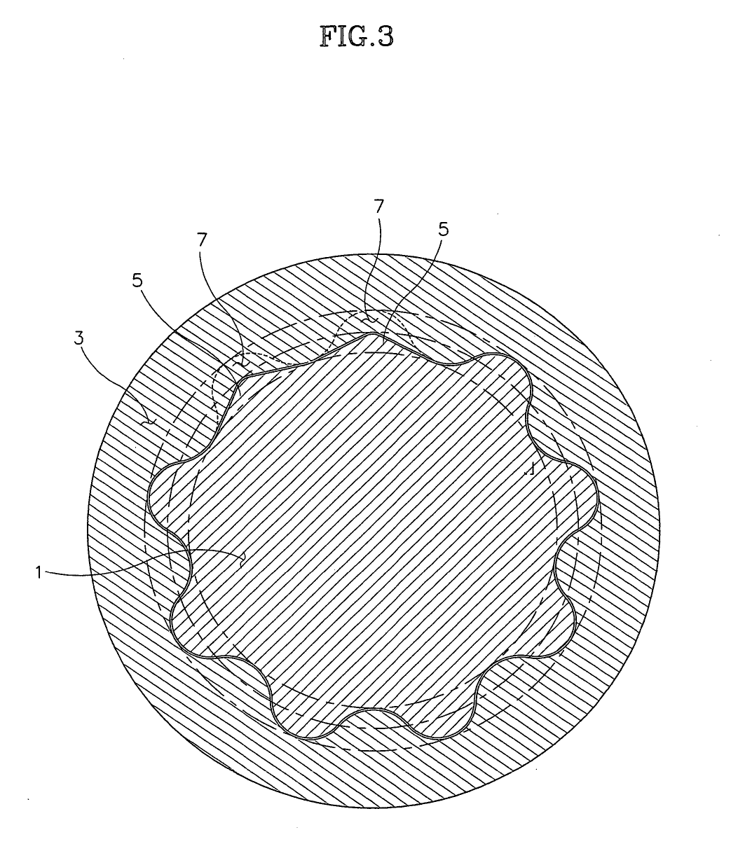

As shown in FIG. 2 or 3, in the case in which the two lower external teeth 5 having the depression parts are asymmetrically positioned to one side, because the hub 3 can be coupled to the shaft 1 only at increments of 360°, the present invention can structurally prevent the hub 3 from being coupled to the shaft 1 at an incorrect angle.

FIG. 3 shows the case in which two lower external teeth 5 having the depression parts are adjacent to each other. This case is a modification of the first embodiment of FIG. 2 showing the two lower external teeth 5 asymmetrically positioned to one side.

Meanwhile, the two lower external teeth 5 having the depression parts have heights ranging from ¼ to ¾ of the height of the other external teeth of the shaft 1. In this embodiment, the height of the two lower external teeth 5 is ½ of the height of the other external teeth.

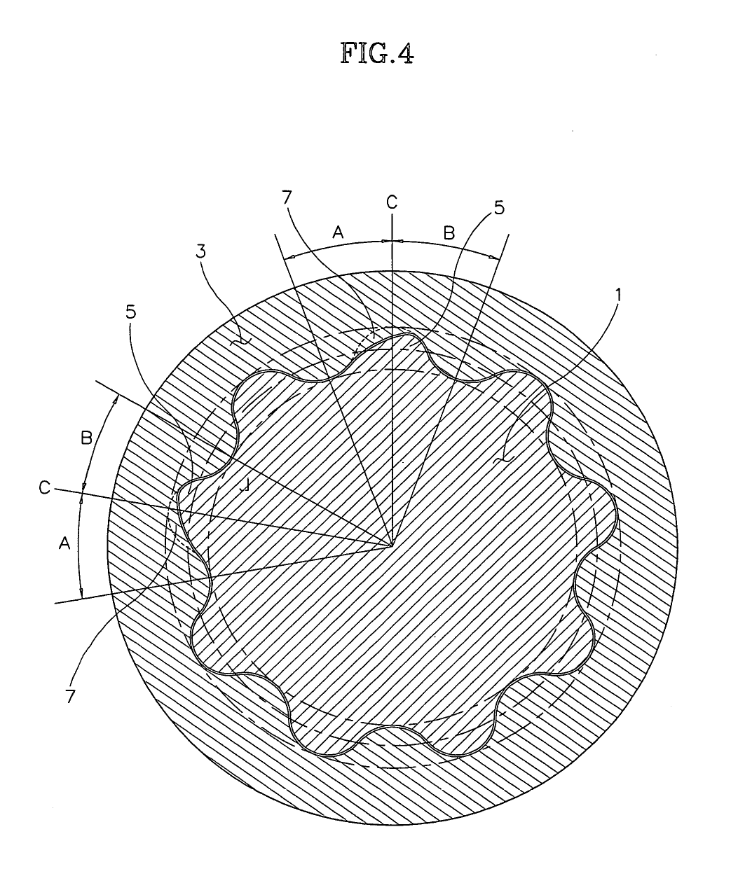

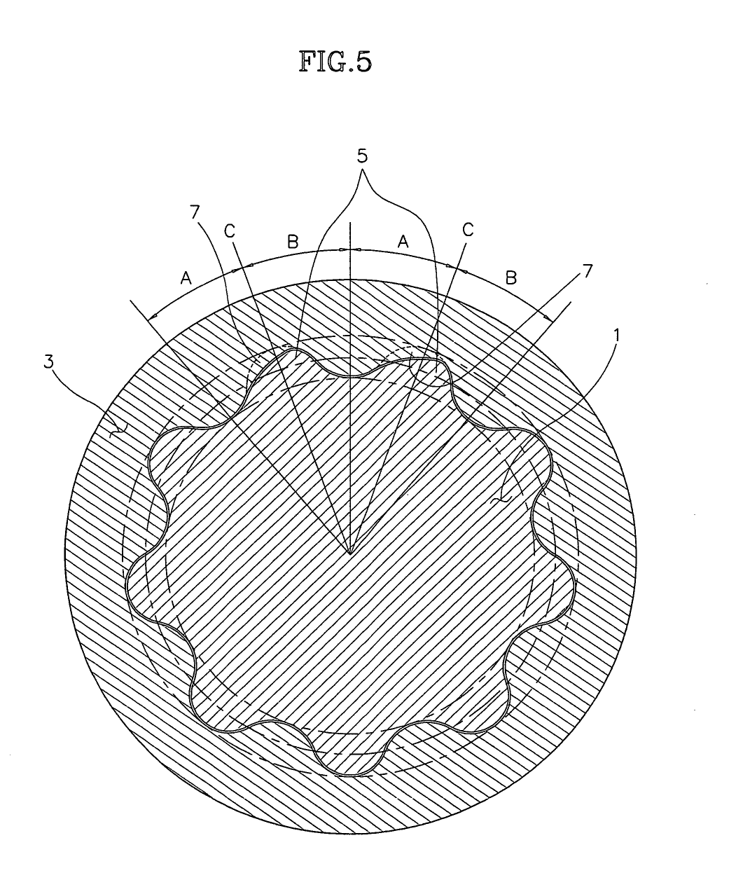

FIGS. 4 and 5 show examples according to a second embodiment of the present invention. In this embodiment, each of two external teeth 5 of a shaft 1 having depression parts has a shape that is gradually skewed in one direction based on a radial axis (C) of each of the external teeth 5. Furthermore, skewed directions of the two external teeth 5 are the same. FIG. 5 shows the case in which two lower external teeth 5 are adjacent to each other, unlike the case shown in FIG. 4.

As shown in each of FIGS. 4 and 5, each lower external tooth 5 has a skewed shape such that the height of the tooth 5 is gradually decreased from section B, which is in a clockwise direction based on the radial axis (C), to section A, which is in a counterclockwise direction based on the radial axis (C), thereby defining the depression part. Furthermore, supplementary root parts 7 of the hub 3 are also skewed to correspond to the above-mentioned skewed shapes of the lower external teeth 5.

This structure makes it possible for the hub 3 to be coupled to the shaft 1 at increments of 360° in the same manner as the first embodiment, thus preventing the hub 3 from being coupled to the shaft 1 at an incorrect angle, and maintaining the constant orientation of the shaft 1.

In detail, the hub 3 is fitted over each of opposite ends of the shaft 1. Here, one end of the shaft 1 may have to be processed by special heat treatment to be prepared for the case where a greater load is applied to that end of the shaft 1 than to the other end of the shaft 1. In this case, the orientation of the shaft 1 to be coupled to the hubs 3 must be taken into account in an assembling process. If each of teeth having depression parts is skewed in a direction as described above, the shaft 1 to be coupled at both ends thereof to the hubs can be oriented in a specified direction.

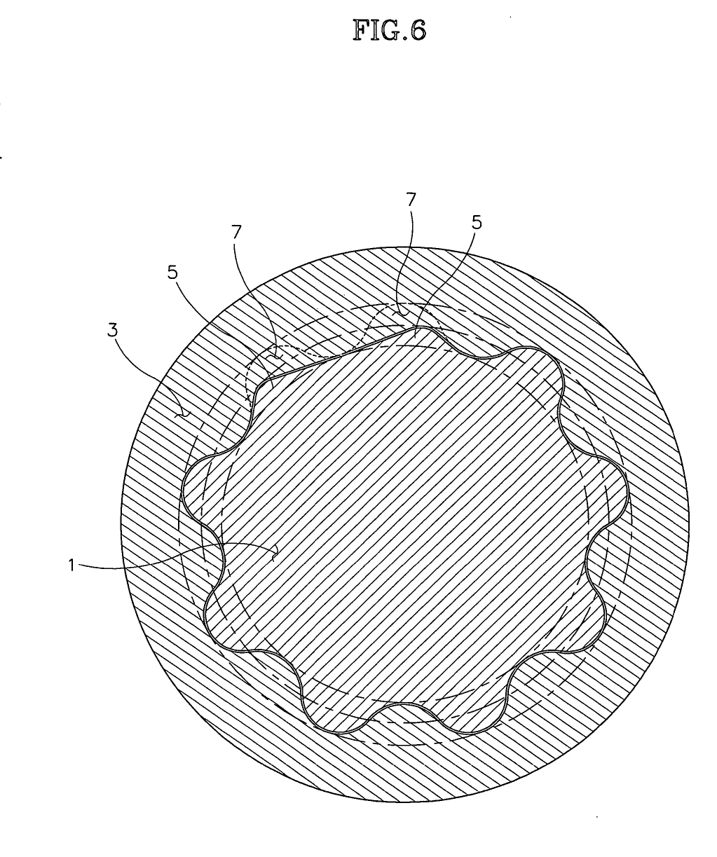

FIG. 6 shows a modification of the second embodiment of FIGS. 4 and 5. In this case, each of two external teeth 5 having depression parts has a shape that is skewed in one direction based on the radial axis of each of the external teeth 5. Here, skewed directions of the two external teeth 5 are opposite to each other. Furthermore, the two external teeth 5 are adjacent to each other. The height of the two lower external teeth 5 is ½ of the height of the other external teeth.

Of course, this case can also prevent the hub 3 from being coupled to the shaft 1 at an incorrect angle and maintain the constant orientation of the shaft 1.

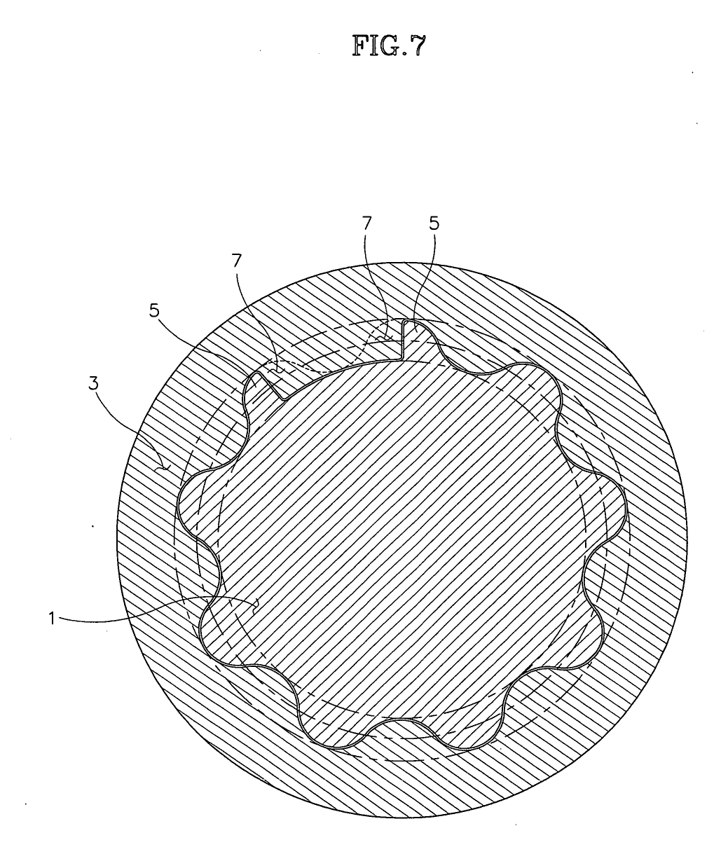

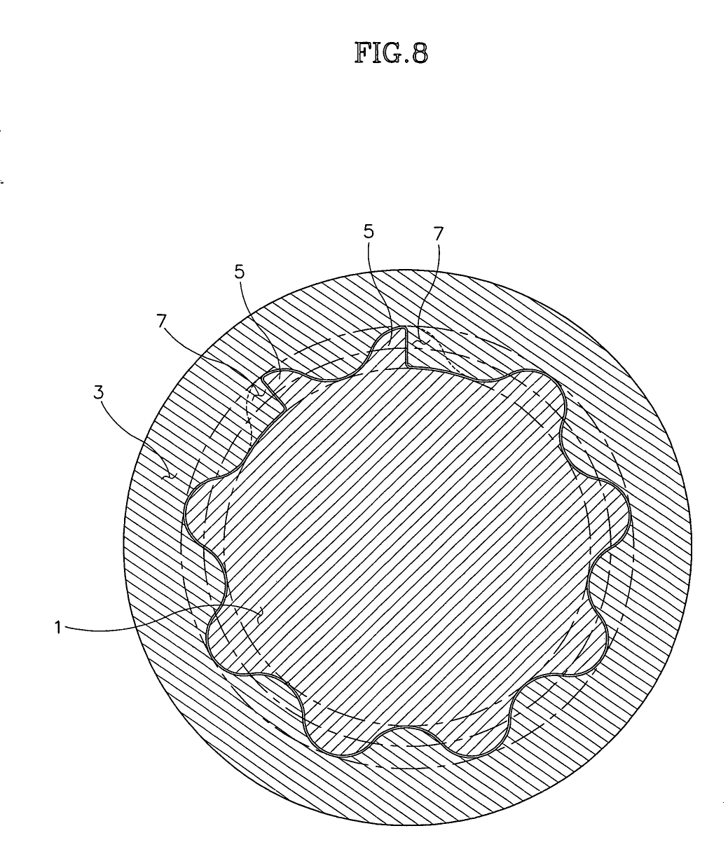

FIGS. 7 and 8 show examples according to a third embodiment of the present invention. In this embodiment, a plurality of external teeth, having the same shape, is provided around a circumferential outer surface of a shaft 1. The external teeth are spaced apart from each other at regular angular intervals. A plurality of internal teeth is provided on an inner edge of a hub 3, into which the shaft 1 is inserted. The internal teeth have the same shape and are spaced apart from each other at regular angular intervals to correspond to spaces between the external teeth of the shaft 1, so that the hub 3 is splined to the shaft 1. Furthermore, depression parts are defined by removing facing portions of two adjacent external teeth of the shaft 1 (see, FIG. 7). Alternatively, depression parts may be defined by removing oppositely facing portions of two adjacent external teeth of the shaft 1 (see, FIG. 8). Furthermore, in each example of the third embodiment, supplementary root parts 7 protrude from the inner edge of the hub 3 to correspond to the depression parts and contact the outer surface of the shaft 1.

Also in this embodiment, only when the orientation of the depression parts corresponds to the orientation of the supplementary root parts 7 can the hub 3 be fitted over the shaft 1. Accordingly, the shaft 1 and the hub 3 are prevented from being incorrectly assembled.

As described above, in the embodiments shown in FIGS. 2 through 7, the outlines of two external teeth 5 among the external teeth of the shaft 1 are lower than the outlines of the other external teeth of the shaft 1, and the supplementary root parts 7 protrude towards the depression parts. Thereby, only when the depression parts and the supplementary root parts 7 correspond to each other can the hub 3 be fitted over the shaft 1. As a result, the shaft 1 and the hubs 3 of the recliners, which are provided on the opposite ends of the shaft 1, are prevented from being incorrectly assembled together.

Furthermore, as shown in FIGS. 4 through 6, in the case in which the two lower external teeth 5 having the depression parts are skewed in predetermined directions based on the radial axis (C) of each tooth, the orientation of the shaft 1 to be coupled to the two hubs 3 of the recliners is specified. Therefore, an assembly condition such that a desired end of the shaft 1 is coupled to the hub 3 of the desired recliner is naturally satisfied.

Moreover, in the structure in which the depression parts are defined on two external teeth 5 among the external teeth of the shaft 1 and the supplementary root parts 7 corresponding to the depression parts are provided on the hub 3, because the two selected external teeth 5 are not completely removed but have the shapes of partial teeth, when rotating force is transmitted between the shaft 1 and the hub 3, load is relatively evenly applied to the shaft 1 and the hub 3 in a circumferential direction.

Consequentially, when the shaft 1 rotates, a tendency for eccentricity to occur between the shaft 1 and the hub 3 is minimized, thus ensuring stable and silent rotation of the shaft 1 and the hub 3.

Furthermore, in the shaft and hub coupling structure of the present invention in which the two selected external teeth 5 for specifying the coupling orientation between the shaft 1 and the hub 3 maintain part of their shapes, there is an advantage of the increased strength of the shaft 1 compared to the case in which selected external teeth or any one tooth is completely removed from the shaft 1.

As described above, the present invention provides a shaft and hub coupling structure for recliners which ensures stable and silent motion of the shaft and hub of the recliner, maintains sufficient strength of the shaft, and makes it possible for a process of coupling the shaft to the hub to be easily and correctly conducted.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A shaft and hub coupling structure for recliners, comprising: a plurality of external teeth protruding from a circumferential outer surface of the shaft, the external teeth spaced apart from each other at regular angular intervals; and a plurality of internal teeth protruding from an inner edge of the hub, into which the shaft is inserted, the internal teeth being spaced apart from each other at regular angular intervals to correspond to spaces between the external teeth of the shaft, so that the hub is splined to the shaft, wherein
two external teeth among the external teeth of the shaft each comprise a depression part which is defined by being more depressed than outlines of other external teeth of the shaft,
the hub comprises supplementary root parts protruding towards the depression parts of the shaft such that, when the hub is oriented in a direction in which the supplementary root parts correspond to the depression parts of the shaft, the hub is fitted over the shaft,
the two external teeth of the shaft, each having the depression part, are asymmetrically positioned to one side based on a center of the shaft in a cross-section of the shaft, and
the supplementary root parts of the hub contact to the two external teeth of the shaft.

2. The shaft and hub coupling structure as set forth in claim 1, wherein the two external teeth each having the depression part have heights ranging from ¼ to ¾ of a height of the other external teeth.

3. The shaft and hub coupling structure as set forth in claim 1, wherein each of the two external teeth having the depression parts has a shape that is skewed in one direction based on a radial axis of each of the external teeth, and
skewed directions of the two external teeth are the same.

4. The shaft and hub coupling structure as set forth in claim 3, wherein the two external teeth each having the depression part are disposed at positions adjacent to each other.

5. The shaft and hub coupling structure as set forth in claim 1, wherein each of the two external teeth having the depression parts has a shape that is skewed in one direction based on a radial axis of each of the external teeth, and
skewed directions of the two external teeth are opposite to each other.

6. The shaft and hub coupling structure as set forth in claim 5, wherein the two external teeth each having the depression part are disposed at positions adjacent to each other.

7. The shaft and hub coupling structure as set forth in claim 1, wherein the depression parts of the shaft are defined by removing facing portions of two adjacent external teeth, and
the supplementary root parts of the hub protrude to correspond to the depression parts and contact the shaft.

8. The shaft and hub coupling structure as set forth in claim 1, wherein the depression parts of the shaft are defined by removing oppositely facing portions of two adjacent external teeth, and
the supplementary root parts of the hub protrude to correspond to the depression parts and contact the shaft.
